(19) United States
(12) Patent Application Publication
(10) Pub. No.: US 2008/0022809 A1
(43) Pub. Date: Jan. 31, 2008

(54) SCREW CAP OPENER

(75) Inventor: Reinhard Renner, Esslingen (DE)

Correspondence Address: DARBY & DARBY P.C., P.O. BOX 770, Church Street Station, New York, NY, 10008-0770, US

(73) Assignee: LEIFHEIT AG, Nassau/Lahn (DE)

(21) Appl. No.: 11/828,477

(22) Filed: Jul. 26, 2007

(30) Foreign Application Priority Data
Jul. 26, 2006 (DE) 10 2006 034 449.9

(51) Int. Cl. B67B 7/18

(52) U.S. Cl. 81/3.44

(57) ABSTRACT

A screw-top opener with two contact strips that are arranged in a V-shaped formation relative to each other and between which a screw top can be positioned in such a way that the contact strips lie against the sides of the screw top is configured in such a way that the two contact strips can be alternately arranged in an operating position or in a space-saving inoperative position. In the operating position, the two contact strips are tangentially in contact with the outer circumference of a screw top that is to be turned.

Priority is claimed to German patent application DE 10 2006 034 449.9, filed Jul. 26, 2006.

The invention relates to a screw-top opener with two contact strips between which a screw top can be positioned in such a way that the contact strips lie against the sides of the screw top.

### BACKGROUND

German utility model DE 20 2004 003 755 U1 describes a screw-top opener that can be operated with one hand, that can be mounted onto a stationary object, and that has two elongated gripping rails arranged opposite from each other. The screw-top opener has a connecting part that rigidly connects the two gripping rails to each other, whereby the first gripping rail has a first contact surface and the second gripping rail has a second contact surface, whereby the two contact surfaces face each other and each have a first end and a second end, whereby the distance between the contact surfaces from each other increases from the first end towards the second end, and whereby the coefficient of friction between the first contact surface and a screw top that is to be opened is greater than the coefficient of friction between the screw top that is to be opened and the second contact surface. The screw-top opener is securely attached to a piece of furniture, for example, to the underside of a tabletop. Due to the fact that the distance between the contact surfaces changes over the length of the gripping rails, the screw tops of all kinds of differently sized containers can be inserted into the opener and opened by turning the container. The screw-top opener has the drawback that it has to be securely attached to a piece of furniture and therefore cannot be used flexibly everywhere. Moreover, the screw-top opener takes up a great deal of space.

German utility model DE 20 2005 008 230 U1 describes a similarly functioning device for opening and closing twist tops, screw tops and crown corks. This device has the drawback that only relatively small rotational forces can be applied to the screw top; this is why it is basically only suitable for opening twist tops of bottles. Moreover, the device takes up a great deal of space so that it is awkward to store it in drawers.

Consequently, it is an objective of the invention to provide a screw-top opener that is easy to store and that also allows a simple opening of different sizes of containers—and especially also of large—containers with screw tops.

### SUMMARY

The present invention provides a screw-top opener including two contact strips. The screw-top opener has an operating position, in which a screw top is held between the two contact strips such that each contact strip lies against a side of the screw top. The screw-top opener also has a space-saving inoperative position.

### BRIEF DESCRIPTION OF THE DRAWINGS

The present invention is elaborated upon below with reference to the drawings, whereby elements having the same function are designated with the same reference numerals. The drawings show:

FIG. 1 a screw-top opener in a partial cut-away view according to one embodiment of the invention, in the operating position,

FIG. 2 the screw-top opener according to the embodiment of FIG. 11 in the operating position, placed onto a screw top

FIG. 3 the screw-top opener according to the embodiment of FIG. 1, in the inoperative position,

FIG. 4 a screw-top opener according to another embodiment of the invention, in the operating position, and

FIG. 5 the screw-top opener according to the embodiment of FIG. 4, in the inoperative position.

### DETAILED DESCRIPTION

The present invention provides a screw-top opener that includes two contact strips which can be alternately arranged in an operating position or in a space-saving inoperative position.

The screw-top opener according to the invention has an advantage that, on the one hand, it can untwist even large screw tops and that, on the other hand, the screw-top opener can be stored in a space-saving manner, for instance in a kitchen drawer.

In one embodiment, the two contact strips are arranged in a V-shaped formation relative to each other. This allows a universal adaptability of the screw-top opener to screw tops of different sizes. Large screw tops are inserted less deeply, while small screw tops are inserted further into the V-shaped arrangement of the two contact strips that face each other.

According to one embodiment of the invention, the screw-top opener is configured in such a way that, in the operating position, the two contact strips are tangentially in contact with the outer circumference of a screw top that is to be turned.

In one embodiment, the two contact strips can be locked in the operating position and unlocked again.

Additionally the two contact strips may be arranged in parallel to each other when they are in the inoperative position.

In an embodiment that allows easy turning of screw tops, the two contact strips are arranged on a handle. In this manner, the lever action of the screw-top opener is increased so that even containers with especially tight screw tops can be easily opened.

In one embodiment, the two contact strips are arranged together on the same handle. It can be provided that the two contact strips are each arranged at the end of the handle.

In a sturdy and easy-to-use embodiment, the screw-top opener in the operating position has a Y-shape in the form of the two contact strips and one handle.

In one embodiment, at least one of the two contact strips is joined to the handle in an articulated manner. For example, it can be provided that at least one of the two contact strips is arranged rotatably on the handle. Alternatively, two contact strips are each arranged rotatably on the handle. In one embodiment, which securely holds the screw top that is to be turned, it is provided that the two contact strips are each arranged on the handle so as to be rotatable around different—possibly parallel—axes of rotation. In this embodiment, it can be provided that, when a force is exerted onto the handle in order to open a screw top, it tilts relative to the two contact strips so that the two contact strips approach each other, which additionally clamps the screw top and thus secures it especially well.

In a specific embodiment, in order for the two contact strips to be moved from the operating position into the inoperative position—similar to a pocket knife—they can be folded against the handle and/or into the handle. Here, it can be provided that the two contact strips lie against the handle when they are in the inoperative position.

In another embodiment in which the two contact strips are well-protected in the inoperative position, it is provided that at least one—possibly both—of the two contact strips are arranged in the handle when they are in the inoperative position.

In yet another embodiment, in order for the two contact strips to be moved from the operating position into the inoperative position, it is provided that at least one of the two contact strips can be slid into the handle.

In an embodiment of the screw-top opener according to the invention with which it is easy to move from the inoperative position into the operating position, a spring mechanism is provided that is biased when the two contact strips are moved from the operating position into the inoperative position. Upon activation—for instance, by operating a release mechanism that can be, for example, a release button—the spring mechanism automatically moves the two contact strips from the inoperative position into the operating position. For this purpose, in order to move the two contact strips from the operating position into the inoperative position, at least one—possibly both—of the two contact strips can be slid into the handle and/or folded against the handle or into the handle counter to the force of the spring mechanism.

In one embodiment, it is provided that at least one of the two contact strips has an adhesive coating and/or teeth and/or ridges and/or roughening for creating a positive and/or non-positive connection to a screw top. Further, both contact strips can be provided with an adhesive coating and/or teeth and/or ridges and/or roughening.

In one embodiment, it is provided that a placement strip is arranged on at least one of the two contact strips which may be perpendicular thereto. When the screw-top opener is positioned correctly, the placement strip rests on the top of the screw top, whereas the contact strip lies on the outer circumference of the screw top.

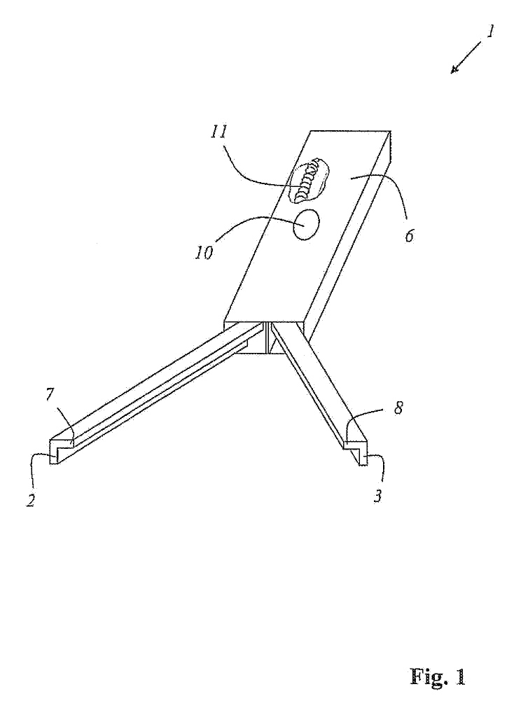

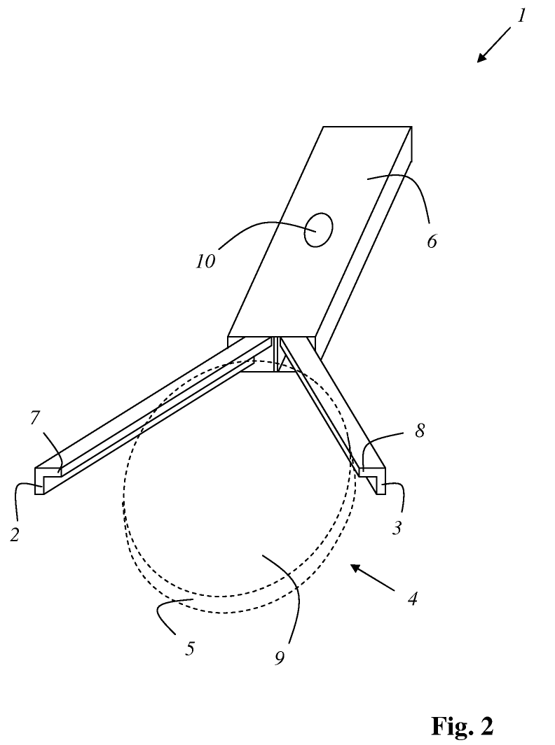

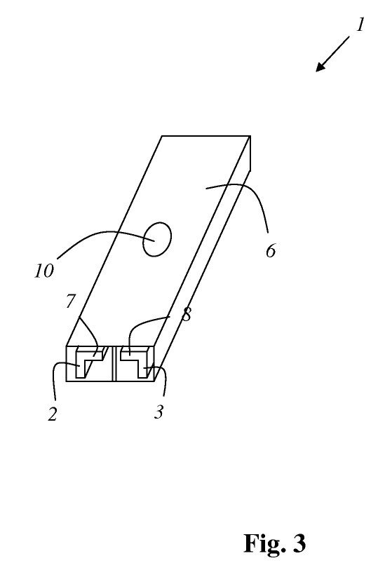

FIG. 1 shows a screw-top opener 1 according to the invention, comprising a first contact strip 2 and a second contact strip 3 in an operating position. A screw top 4 can be positioned between the first contact strip 2 and the second contact strip 3 in such a way that the first contact strip 2 and the second contact strip 3 lie against the outer circumferential surface 5 of the side of the screw top. This situation is shown in FIG. 2. It can be clearly seen that, in the operating position shown here, the first contact strip 2 and the second contact strip 3 are arranged in a V-shaped formation relative to each other. The first contact strip 2 and the second contact strip 3 are arranged on a handle 6. In the operating position shown here, the screw-top opener 1 has a Y-shape made up of the first contact strip 2, the second contact strip 3 and the handle 6. The first contact strip 2 and the second contact strip 3 can be slid into the handle 6 counter to the force of a spring mechanism 11 and thus moved from the operating position into the inoperative position. This is shown in FIG. 3. A first placement strip 7 is arranged on the first contact strip 2. A second placement strip 8 is arranged on the second contact strip 3. The first placement strip 7 and the second placement strip 9 facilitate the quick and precise placement of the screw-top opener 1 on a screw top 4. When the screw-top opener is positioned correctly, the first placement strip 7 and the second placement strip 8 rest on the top 9 of the screw top 4, whereas the first contact strip 2 and the second contact strip 3 are tangentially in contact with the outer circumferential surface 5 of the screw top. A release button 10 is provided with which the first contact strip 2 and the second contact strip 3, together with the placement strips 7, 8 arranged on them, can be moved from the inoperative position into the operating position by means of the spring mechanism 11.

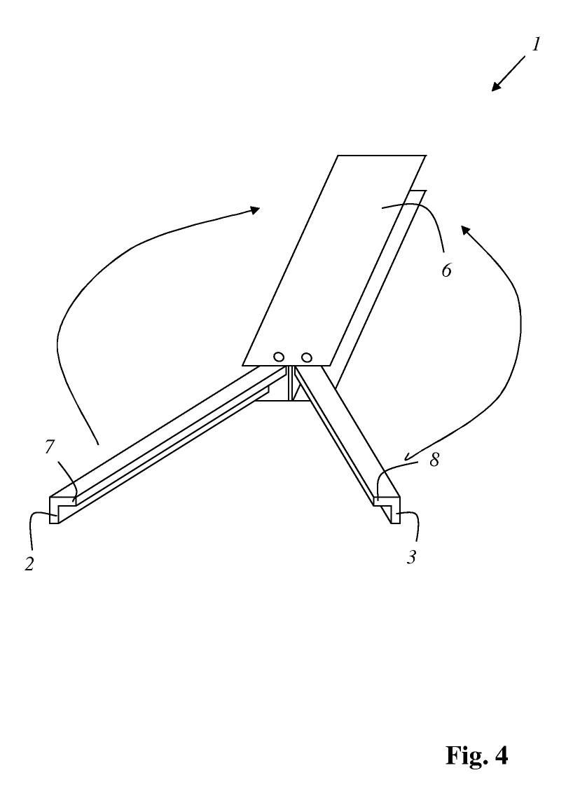

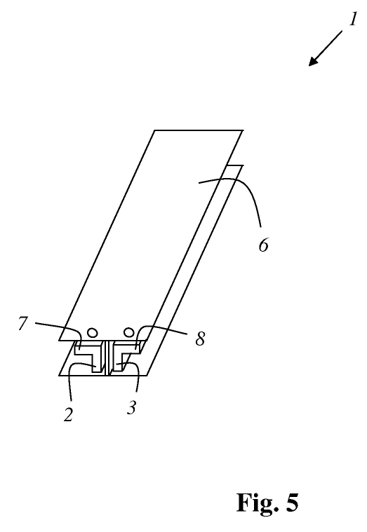

FIG. 4 shows another screw-top opener 1 according to the invention having a first contact strip 2 on which a first placement strip 7 is arranged, and having a second contact strip 3 on which a second placement strip 8 is arranged. The first contact strip 2 and the second contact strip 3, along with their placement strips 7, 8, are arranged rotatably on a handle 6. They can be temporarily locked in the operating position shown. In order to move the first contact strip 2 and the second contact strip 3 from the operating position into the inoperative position, the lock is released; subsequently, the first contact strip 2 and the second contact strip 3, together with the placement strips 7, 8 arranged on them, are each folded into the handle 6, similar to a pocket knife. In the inoperative position achieved in this manner and shown in FIG. 5, the screw-top opener 1 is compact and can be stored easily.

The invention was described with reference to a specific embodiment. However, it goes without saying that changes and modifications can be made without departing from the protective scope of the claims given below.

### LIST OF REFERENCE NUMERALS

1 screw-top opener
2 first contact strip
3 second contact strip
4 screw top
5 outer circumferential surface of the screw top
6 handle
7 first placement strip
8 second placement strip
9 top of the screw top
10 release button

1-21. (canceled)

22. A screw-top opener comprising:
a first contact strip; and
a second contact strip;
wherein the first and second contact strips are configured to receive a screw top therebetween in an operating position of the contact strips so that each contact strip lies against a respective side portion of the screw top, and
wherein the first and second contact strips are configured to be alternately disposed in the operating position and in a space-saving inoperative position.

23. The screw-top opener recited in claim 22 wherein the contact strips are disposable in a V-shaped formation.

24. The screw-top opener recited in claim 22 wherein each respective side portion of the screw top is disposed at an outer circumference of the screw top so that in the operating position the contact strips are each operable to be tangentially in contact with the outer circumference of the screw top.

25. The screw-top opener recited in claim 22 wherein the contact strips are lockable in the operating position.

26. The screw-top opener recited in claim 22 wherein the contact strips are disposed parallel to each other in the inoperative position.

27. The screw-top opener recited in claim 22 further comprising a handle connected to the contact strips.

28. The screw-top opener recited in claim 27 wherein the handle includes a first end and each of the two contact strips are connected to the handle at the first end.

29. The screw-top opener recited in claim 27 wherein the handle and contact strips are disposed in a Y-shape in the operating position of the contact strips.

30. The screw-top opener recited in claim 27 wherein the contact strips are connected to the handle in an articulated manner.

31. The screw-top opener recited in claim 27 wherein at least one of the contact strips is rotatably connected to the handle.

32. The screw-top opener recited in claim 27 wherein the contact strips are rotatably connected to the handle, the contact strips being rotatable about different axes of rotation.

33. The screw-top opener recited in claim 32 wherein the axes of rotation are parallel.

34. The screw-top opener recited in claim 26 wherein the contact strips lie against the handle in the inoperative position.

35. The screw-top opener recited in claim 27 wherein at least one of the contact strips are disposed in the handle in the inoperative position.

36. The screw-top opener recited in claim 27 wherein at least one of the contact strips is foldable into or against the handle so as to move from the operating position into the inoperative position.

37. The screw-top opener recited in claim 27 wherein at least one of the contact strips is slidable so as to move from the operating position into the inoperative position.

38. The screw-top opener recited in claim 27 further comprising a spring mechanism operable to bias at least one of the contact strips into the operating position, and wherein the at least one contact strip is operable to be slid into the handle against the bias of the spring mechanism.

39. The screw-top opener recited in claim 22 further comprising:
a spring mechanism operable to bias the contact strips into the operating position, and
a release mechanism operable to release the contact strips from the inoperative position.

40. The screw-top opener recited in claim 22 wherein at least one of the contact strips includes at least one of an adhesive coating, teeth, ridges, and roughening.

41. The screw-top opener recited in claim 22 further comprising a placement strip disposed on at least one of the contact strips.

42. The screw-top opener recited in claim 41 wherein the placement strip projects perpendicularly from the at least one of the contact strips.
